(19) United States
(12) Patent Application Publication
(10) Pub. No.: US 2014/0075247 A1
(43) Pub. Date: Mar. 13, 2014

(54) METHOD OF GETTING OUT FROM ERROR ENTERING INTO TEST MODE IN USB3.0 APPARATUS

(71) Applicant: ALGOLTEK, INC., TAOYUAN CITY (TW)

(72) Inventors: Chia-Chun LIN, Taoyuan (TW); Sheng-Chieh Chan, Taoyuan (TW); Dalee Zhang, Taoyuan (TW)

(21) Appl. No.: 13/943,014

(22) Filed: Jul. 16, 2013

Related U.S. Application Data
(60) Provisional application No. 61/699,697, filed on Sep. 11, 2012.

(51) Int. Cl. G06F 11/36

(52) U.S. Cl. CPC G06F 11/3636
USPC 714/38.12

(57) ABSTRACT

The present invention discloses a method of getting out from error entering into test mode in USB3.0 apparatus, in which extra status states are inserted into the compliance mode in the original state diagram of the link training and status state machine of the conventional USB3.0 protocol. The inserting status states are to set up a timer, and go to power saving state U1, U2, or U3 or SS.Disable state when timeout happens. The insertion of the timer will not change the normal compliance tests required by the conventional USB3.0 protocol because a Ping.LFPS will always force the state go from power saving state U1, U2 or U3 to compliance mode, and the Ping.LFPS is always needed in normal compliance tests.

### BACKGROUND OF THE INVENTION

1. Technical Field

The present invention relates to a method of getting out from error entering into test mode in USB3.0 apparatus. More particularly, the present invention relates to a method by using insertion of a timer to get out from error entering into test mode in USB3.0 apparatus.

2. Description of Related Art

To ensure the proper linking and operations of all USB3.0 apparatus, USB3.0 has a protocol of compliance mode for testing device compliances. However, it is not necessarily that all apparatus enter into a compliance mode only in compliance testing, other possible reasons for USB3.0 devices to enter into the compliance mode are: when USB Host enters into power saving mode and when VBUS 5V is on while the terminal resistance component is not removed.

USB3.0 apparatus transmits and receives high speed testing signals during the compliance mode which consumes power continuously, and that is a drawback of consuming unnecessary power when devices go into the unwanted compliance mode for testing compliance.

### BRIEF SUMMARY OF THE INVENTION

The present invention discloses a method of getting out from error entering into test mode in USB3.0 apparatus, in which extra status states are inserted into the compliance mode in the original state diagram of the link training and status state machine of the conventional USB3 .0 protocol. The inserting status states are to set up a timer, and go to power saving state U1, U2, or U3 or SS.Disable state when timeout happens. The insertion of the timer will not change the normal compliance tests required by the conventional USB3.0 protocol because a Ping.LFPS will always force the state go from power saving state U1, U2 or U3 to compliance mode, and the Ping.LFPS is always needed in normal compliance tests.

To achieve these and other effects, the present invention provides A method of getting out from error entering into test mode in USB3.0 apparatus, the method comprises the following steps: entering Compliance Mode, wherein the USB3.0 apparatus does compliance tests in the Compliance Mode; setting a timer and checking for time out, wherein a timer is set according to a defined value and starts counting till time out, the USB3.0 apparatus goes to entering Compliance Mode when a No is detected in checking for time out; entering U3 or U1 or U2 or SS.Disable, wherein the USB3.0 apparatus goes to entering U3 or U1 or U2 or SS.Disable when a Yes is detected in checking for time out, and the USB3.0 apparatus performs power saving when entering the U3 or U1 or U2 or SS.Disable; and entering Polling, wherein the USB3.0 apparatus performs access functions defined by a USB3.0 protocol in Polling mode.

To achieve the above mentioned and other effects, the present invention provides another method of getting out from error entering into test mode in USB3 .0 apparatus, the method comprises the following steps: entering Compliance Mode, wherein the USB3 .0 apparatus does compliance tests in Compliance Mode; setting a timer and checking for time out, wherein a timer is set according to a defined value and starts counting till time out, the USB3.0 apparatus goes to entering Compliance Mode when a No is detected in checking for time out; entering U3 or U1 or U2 or SS.Disable, wherein the USB3.0 apparatus goes to entering U3 or U1 or U2 or SS.Disable when a Yes is detected in checking for time out, and the USB3.0 apparatus performs power saving when entering the U3 or U1 or U2 or SS.Disable; and entering Polling, wherein the USB3.0apparatus performs access functions defined by a USB3.0 protocol in Polling mode.

By implementing the present invention, at least the following progressive effects can be achieved:

1. Automatic going out from error entering into compliance mode.

2. Automatic stopping of transmitting high speed signals when error entering into compliance mode.

3. Power saving by eliminating unnecessary going into compliance mode when using USB3.0 apparatus.

The features and advantages of the present invention are detailed hereinafter with reference to the preferred embodiments. The detailed description is intended to enable a person skilled in the art to gain insight into the technical contents disclosed herein and implement the present invention accordingly. In particular, a person skilled in the art can easily understand the objects and advantages of the present invention by referring to the disclosure of the specification, the claims, and the accompanying drawings.

BRIEF DESCRIPTION OF THE SEVERAL VIEWS OF THE DRAWINGS

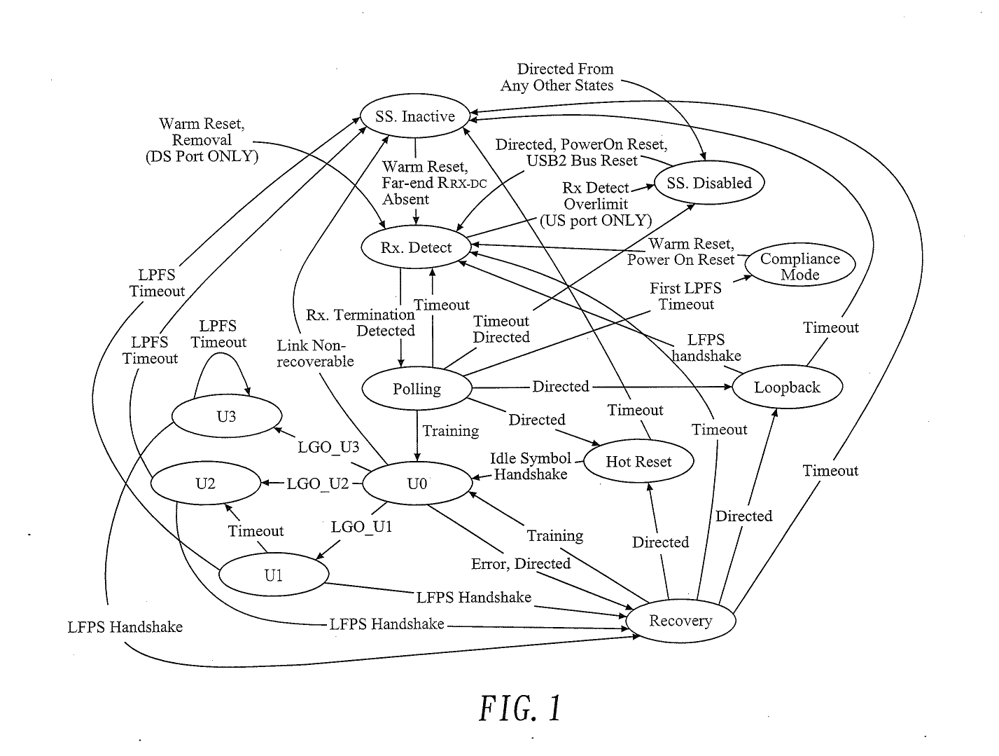

FIG. 1 is a state diagram of the link training and status state machine of conventional USB3.0 protocol;

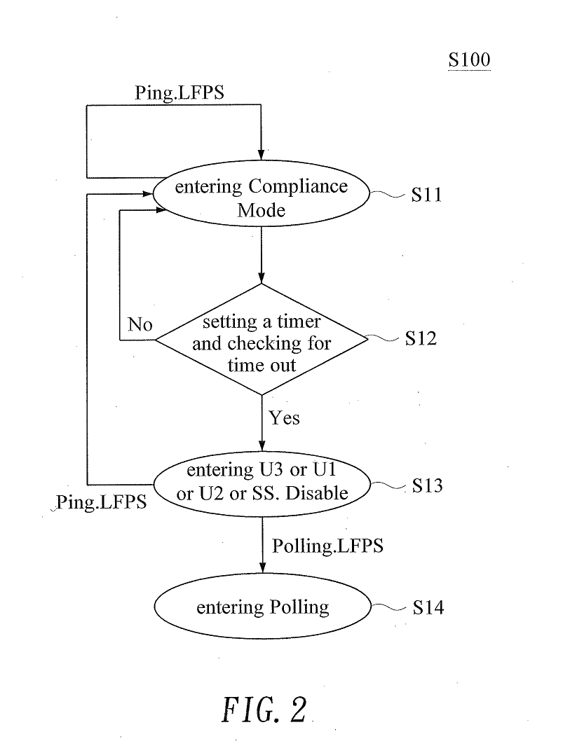

FIG. 2 is a flow chart of the process steps of an embodiment of a method of getting out from error entering into test mode in USB3.0 apparatus of the present invention;

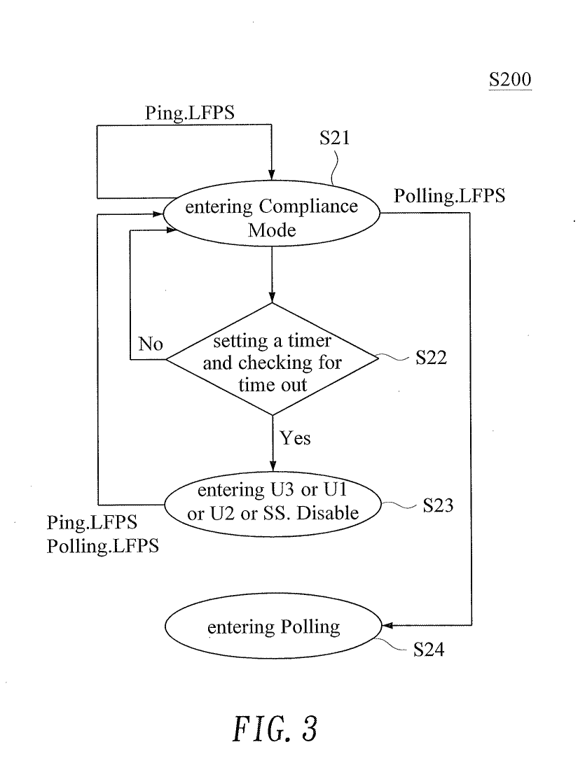

FIG. 3 is a flow chart of the process steps of another embodiment of a method of getting out from error entering into test mode in USB3.0 apparatus of the present invention; and

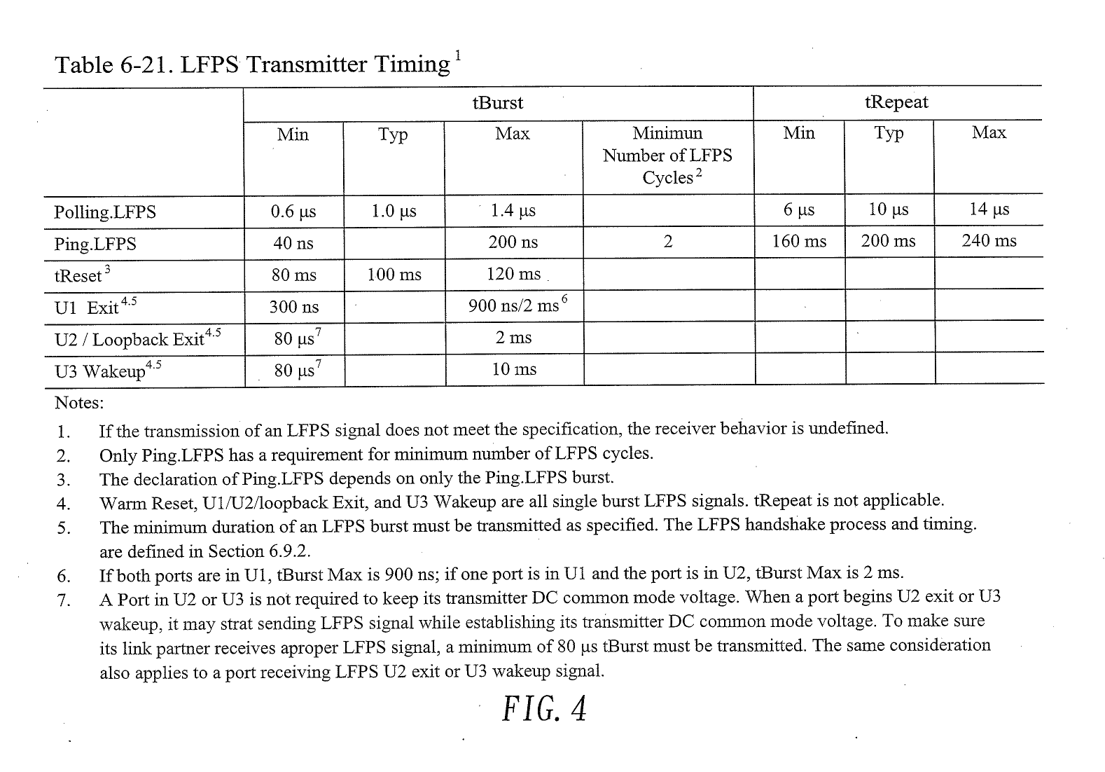

FIG. 4 is a timing specification of LFPS (Low Frequency Periodic Signal).

### DETAILED DESCRIPTION OF THE INVENTION

As shown in FIG. 2 to FIG. 3 are flow chart embodiments of a method of getting out from error entering into test mode in USB3.0 apparatus of the present invention. in which extra status states are inserted into the compliance mode in the original state diagram of the link training and status state machine of the conventional USB3.0 protocol as shown in FIG. 1. The inserting status states are to set up a timer, and go to power saving state U1 or U2 or U3 or SS.Disable state when timeout happens.

The insertion of the timer will not change the normal compliance tests required by the conventional USB3.0 protocol because a Ping.LFPS signal will always force the state mode go from power saving state mode U1 or U2 or U3 or SS.Disable to Compliance Mode, wherein the Ping.LFPS signal is always generated in normal compliance tests.

When it is an error entering into the compliance mode, the state will move to power saving state mode U 1 or U2 or U3 or SS.Disable when timeout happens, and stay in power saving state mode U1 or U2 or U3 or SS.Disable and then stop all transmissions of high speed signals until the Host wakes up.

The three situations (situation 1A˜situation 1C) for the Host to wake up are further described as below:
1A: SS.Disable→Rx.Detect→Polling state mode;
1B: U1/U2/U3→LFPS Handshake→Recovery state mode; and
1C: U1/U2/U3→LFPS Timeout→SS.Inactive state mode→Host release a WarnReset→Rx.Detect→Polling state mode.

And in the Host wake up situations 1A to 1C, a device responses differently as below according to different LFPS signals received from the Host:

Response 2A: When a device receives a Polling.LFPS signal, the device goes from U1/U2/U3/SS.Disable (state mode U1 or U2 or U3 or SS.Disable) into the Polling state mode, or go back to the Compliance Mode and wait for another Polling.LFPS to go to the Polling state mode; and

Response 2B: A device responses as the state diagram LTSSM as shown in FIG. 1 when receiving “U1 Exit” to exit from the power saving state mode U1; or “U2/loopback Exit” to exit from the power saving state mode U2; or “U3 Wakeup” to exit from the power saving state mode U3.

Wherein the timing specification of LFPS (Low Frequency Periodic Signal) can be found in the original specification documentations of USB3.0, and is attached and shown in FIG. 4 for reference.

With the implantation of the present invention, USB3.0 apparatus can automatically go out from error entering into the compliance mode and execute power saving states U1, U2 or U3 or SS.Disable state, thereby to accomplish power saving.

To achieve the above objective, the first embodiment of the disclosed method of getting out from error entering into test mode in USB3.0 apparatus includes a few extra status states inserted in the original state machine is described as follows.

As shown in FIG. 2 is a method (S100) of getting out from error entering into test mode in USB3.0 apparatus, the method (S100) comprises the following steps: entering Compliance Mode (step S11), setting a timer and checking for time out (step S12), entering U3 or U1 or U2 or SS .Disable (step S13) and entering Polling (step S14).

As shown in FIG. 2, the state of interest starts from the entering Compliance Mode (step S11) in an original state machine as described in USB3.0 specifications (please refer FIG. 1 or USBIF USB3.0 specifications). Entering Compliance Mode (step S11) is for the state machine to go into compliance tests mode. When a Ping.LFPS is detected in the compliance tests mode, the USB3.0 apparatus remains in the entering Compliance Mode (step S11).

Setting a timer and checking for time out (step S12) is to set up a timer and to start counting the elapse time of the compliance mode, and check the time out condition. The timer keeps counting when time out condition is a No, and the USB3.0 apparatus goes to entering U3 or U1 or U2 or SS.Disable (step S13) when the time out condition is a Yes.

If a Ping.LFPS occurs in the entering Compliance Mode (step S11) while the timer is running, the USB3.0 apparatus goes looping back to the entering Compliance Mode (step S11) and executes next test pattern according to the original USB3.0 protocol (there are CP0˜CP8, total 9 CP patterns in the testing of the compliance tests).

When the condition of the checking for time out is positive (a Yes), the USB3.0 apparatus goes to entering U3 or U1 or U2 or SS.Disable (step S13) as is also shown in FIG. 2 and performs power saving. The power saving state mode U3 or U1 or U2 or SS.Disable works also as in the state machine diagram of the original USB3.0 protocol as shown in FIG. 1.

The checking of relating actions for a Polling.LFPS signal or a Ping.LFPS signal in power saving state mode U3 or U1 or U2 or SS.Disable is, of course, as the original USB3.0 state diagram in the USB3.0 protocol. The USB3.0 apparatus goes from power saving state mode U3 or U1 or U2 or SS.Disable to the step entering Polling (step S14) when a Polling.LFPS occurs in the entering U3 or U1 or U2 or SS.Disable (step S13). The USB3.0 apparatus goes back to the entering Compliance Mode (step S11) and executes next test pattern of compliance tests when a Ping.LFPS occurs in the power saving step entering U3 or U1 or U2 or SS.Disable (step S13).

The step entering Polling (step S14) will be active only when a Polling.LFPS is detected or received in the entering U3 or U1 or U2 or SS.Disable (step S13). The step entering Polling (step S14) is for the USB3.0 state machine to execute access functions as defined by USB3.0 protocol.

As the embodiment of the present invention shown in FIG. 2, the entering

Compliance Mode (step S11) will do normal compliance tests because there will always be Ping.LFPS in normal compliance tests. And when it is an error entering into the entering Compliance Mode (step S11), there is no Ping.LFPS, and a timer is set and checked for time out to make sure the USB3.0 apparatus goes out of the entering Compliance Mode (step S11) and energy is saved.

Please refer to FIG. 3, there is another embodiment of the present invention of a method (S200) of getting out from error entering into test mode in USB3.0 apparatus, the method (S200) comprises the following status step modes: entering Compliance Mode (step S21), setting a timer and checking for time out (step S22), entering U3 or U1 or U2 or SS.Disable (step S23) and entering Polling (step S24). A timer and checking for time out is also inserted to the original state diagram of USB3.0 protocol as in FIG. 1.

As shown in FIG. 3, the state of interest starts from the entering Compliance Mode (step S21) in an original state machine as described in USB3.0 specifications. Entering Compliance Mode (step S21) is for the USB3.0 apparatus to go into compliance tests mode. When a Ping.LFPS is detected in the compliance tests mode, the USB3.0 apparatus remains in the entering Compliance Mode (step S11).

As also shown in FIG. 3, then the USB3.0 apparatus proceeds to setting a timer and checking for time out (step S22) for the setting up of a timer to start counting the elapse time of the compliance tests, and check for time out condition.

If a Ping.LFPS occurs in the entering Compliance Mode (S21) while the timer is running, the state of the USB3.0 apparatus goes looping back to the entering Compliance Mode (S21) and executes next test pattern according to the original USB3.0 protocol (there are CP0˜CP8, total 9 CP patterns in the testing of compliance tests).

If a Polling.LFPS occurs in the entering Compliance Mode (S21) in this embodiment, the state of the USB3.0 apparatus goes directly to the entering Polling (step S24) and executes access functions as the original USB3.0 protocol assigns in the USB3.0specifications.

When the condition of the checking of timer in the setting a timer and checking for time out (step S22) is negative (a No), the state of the USB3.0 apparatus goes back to the entering Compliance Mode (S21) and keeps doing the compliance tests.

Otherwise, if neither Ping.LFPS nor Polling.LFPS occurs and the condition of the checking of timer in the setting a timer and checking for time out (step S22) is positive (a Yes), the state of the USB3.0 apparatus goes to the power saving state mode entering U3 or U1 or U2 or SS.Disable (step S23) as shown in FIG. 3.

The power saving state mode entering U3 or U1 or U2 or SS.Disable (step S23) works also as in the state machine diagram of the original USB3.0 protocol as shown in FIG. 1. The checking for Polling.LFPS or Ping.LFPS in power saving state mode entering U3 or U1 or U2 or SS.Disable (step S23) is the same as the checking of power saving state mode entering U3 or U1 or U2 or SS.Disable (step S23) in the original USB3.0 state diagram, and the state of the USB3.0 apparatus goes from power saving state mode entering U3 or U1 or U2 or SS.Disable (step S23) back to entering Compliance Mode (S21) when a Polling.LFPS or a Ping.LFPS occurs, and executes next pattern of compliance tests as assigned in the original USB3.0 protocol.

As the embodiment of the present invention shown in FIG. 3, the entering Compliance Mode (S21) will do normal compliance tests because there will always be Ping.LFPS in normal compliance tests. And when it is an error entering into the entering Compliance Mode (S21), there is no Ping.LFPS, and a timer is set and checked for time out to make sure the state goes out of the Compliance Mode (S21) and energy is saved.

The embodiments described above are intended only to demonstrate the technical concept and features of the present invention so as to enable a person skilled in the art to understand and implement the contents disclosed herein. It is understood that the disclosed embodiments are not to limit the scope of the present invention. Therefore, all equivalent changes or modifications based on the concept of the present invention should be encompassed by the appended claims.

What is claimed is:

1. A method of getting out from error entering into test mode in USB3.0 apparatus, the method comprises the following steps:
entering Compliance Mode, wherein the USB3.0 apparatus does compliance tests in the Compliance Mode;
setting a timer and checking for time out, wherein a timer is set according to a defined value and starts counting till time out, the USB3.0 apparatus goes to entering Compliance Mode when a No is detected in checking for time out;
entering U3 or U1 or U2 or SS.Disable, wherein the USB3.0 apparatus goes to entering U3 or U1 or U2 or SS.Disable when a Yes is detected in checking for time out, and the USB3.0 apparatus performs power saving when entering the U3 or U1 or U2 or SS.Disable; and
entering Polling, wherein the USB3.0 apparatus performs access functions defined by a USB3.0 protocol in Polling mode.

2. The method of getting out from error entering into test mode in USB3.0 apparatus of claim 1, wherein the USB3.0 apparatus goes to entering Compliance Mode when a Ping.LFPS is detected.

3. The method of getting out from error entering into test mode in USB3.0 apparatus of claim 1, wherein the USB3.0 apparatus goes to entering Polling when a Polling.LFPS signal is detected.

4. A method of getting out from error entering into test mode in USB3.0 apparatus, the method comprises the following steps:
entering Compliance Mode, wherein the USB3.0 apparatus does compliance tests in Compliance Mode;
setting a timer and checking for time out, wherein a timer is set according to a defined value and starts counting till time out, the USB3 .0 apparatus goes to entering Compliance Mode when a No is detected in checking for time out;
entering U3 or U1 or U2 or SS.Disable, wherein the USB3.0 apparatus goes to entering U3 or U1 or U2 or SS.Disable when a Yes is detected in checking for time out, and the USB3.0 apparatus performs power saving when entering the U3 or U1 or U2 or SS.Disable; and
entering Polling, wherein the USB3.0 apparatus performs access functions defined by a USB3.0 protocol in Polling mode.

5. The method of getting out from error entering into test mode in USB3.0 apparatus of claim 4, wherein the USB3.0 apparatus goes to entering Compliance Mode when a Ping.LFPS is detected.

6. The method of getting out from error entering into test mode in USB3.0 apparatus of claim 4, wherein the USB3.0 apparatus goes to entering Polling when a Polling.LFPS signal is detected in entering Compliance Mode.

7. The method of getting out from error entering into test mode in USB3.0 apparatus of claim 4, wherein the USB3.0 apparatus goes to entering Compliance Mode when a Polling.LFPS signal is detected in entering U3 or U1 or U2 or SS.Disable.
